(19) United States
(12) Patent Application Publication
(10) Pub. No.: US 2009/0196359 A1
(43) Pub. Date: Aug. 6, 2009

(54) METHODS AND SYSTEMS TO INSERT FILLER DATA IN UNALLOCATED RESOURCE REGIONS OF A FRAME

(75) Inventor: David P. MAGEE, Allen, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/023,435

(22) Filed: Jan. 31, 2008

(51) Int. Cl. H04K 1/10

(52) U.S. Cl. 375/260

(57) ABSTRACT

In at least some embodiments, a system comprises a first device that prepares a frame for transmission and a second device in communication with the first device. The first device is configured to identify unallocated resource regions in the prepared frame and insert filler data in the unallocated resource regions.

### FIELD OF THE INVENTION

The present disclosure is directed to communication systems, and more particularly, but not by way of limitation, to Orthogonal Frequency Division Multiple Access (OFDMA) communication systems.

### BACKGROUND

In some communication systems, such as Orthogonal Frequency Division Multiple Access (OFDMA), over-the-air resource allocations can span frequency as well as time. During the resource allocation process, some resource regions may go unallocated (e.g., due to scheduling factors such as number of users, throughput and latency). Efforts to improve resource allocation are ongoing.

### SUMMARY

In at least some embodiments, a system comprises a first device that prepares a frame for transmission and a second device in communication with the first device. The first device is configured to identify unallocated resource regions in the prepared frame and insert filler data in the unallocated resource regions.

According to another embodiment, a transmitter comprises a scheduler and a frame constructor coupled to the scheduler. The frame constructor allocates time/frequency resource regions for a frame based on information from the scheduler. The transmitter further comprises a filler data controller coupled to the frame constructor. If a resource region goes unallocated, the filler data controller inserts filler data in the unallocated resource region.

In at least some embodiments, a method comprises preparing a frame for wireless communication and identifying whether the frame has an unallocated resource region. If the frame has an unallocated resource region, the method comprises inserting filler data in the unallocated resource region.

### BRIEF DESCRIPTION OF THE DRAWINGS

For a detailed description of various embodiments of the invention, reference will now be made to the accompanying drawings in which:

FIG. 1 illustrates an Orthogonal Frequency Division Multiple Access (OFDMA) frame in accordance with embodiments of the disclosure;

FIG. 2 illustrates a system in accordance with embodiments of the disclosure;

FIG. 3 illustrates a transmitter in accordance with embodiments of the disclosure;

FIG. 4 illustrates a receiver in accordance with embodiments of the disclosure;

FIG. 5 illustrates a transmitter method in accordance with embodiments of the disclosure

FIG. 6 illustrates a receiver method in accordance with embodiments of the disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection

### DETAILED DESCRIPTION

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the disclosure allocate resources (e.g., in the frequency and time domains) for wireless communication. If a resource region goes unallocated, embodiments insert filler data into the unallocated resource region. The filler data may be random data or some predetermined data (not just zeros). In this manner, the signal power for symbols with allocated resource regions is approximately the same as the signal power for symbols with one or more unallocated resource regions. In other words, a desirable signal-to-noise ratio (SNR) for symbols is maintained even if some symbols represent only allocated resource regions and other symbols represent unallocated resource regions or a combination of allocated and unallocated resource regions. If desired, the unallocated resource regions can be used to pass control data between devices (e.g., between a base station and user equipment).

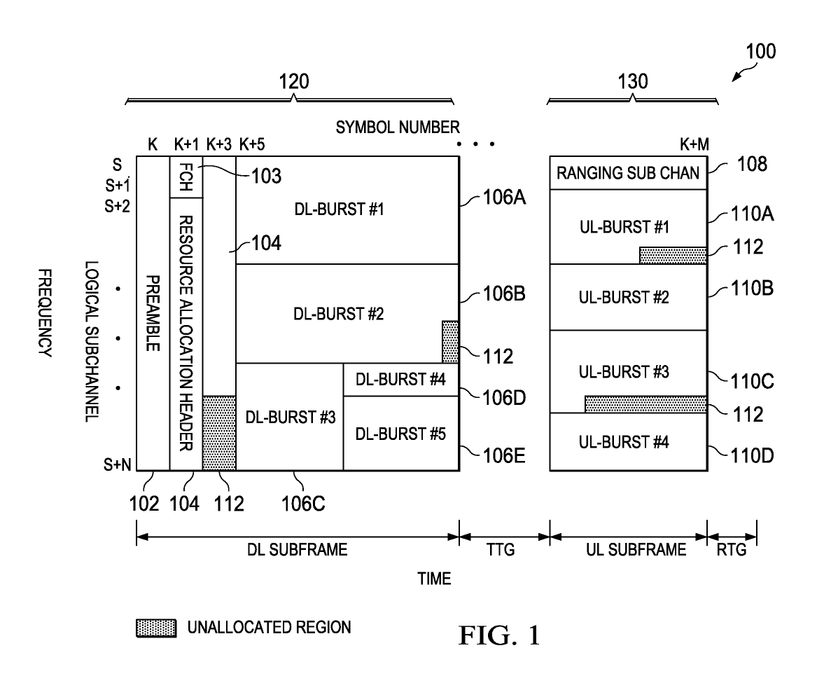

FIG. 1 illustrates an Orthogonal Frequency Division Multiple Access (OFDMA) frame 100 in accordance with embodiments of the disclosure. Although this frame structure represents a TDD (Time Division Duplex) communication system, the principles disclosed in this application are also applicable to other duplexing schemes such as FDD (Frequency Division Duplex). As shown in FIG. 1, the OFDMA frame 100 has a downlink (DL) subframe 120 followed by an uplink subframe 130. The DL subframe 120 and the UL subframe 130 are transmitted as a plurality of symbols (referred to as symbols “k” to “k+M”). Each symbol corresponds to a plurality of frequencies (referred to as logical sub-channels “s” to “s+N”) at a particular time designation. A transmit transition gap (TTG) divides the DL subframe 120 and the UL subframe 130. Also, a receive transition gap (RTG) follows the UL subframe 130.

In at least some embodiments, the DL subframe 120 begins with a preamble 102, which is used by receiving devices for synchronization and channel estimation. Following the preamble 102 is a frame control header (FCH) 103, which specifies the sub-channel groups to be used, the burst profile, and the length of the DL-mobile application part (MAP) message included in the resource allocation header 104. The DL-MAP specifies resource allocations for DL-bursts 106A-106E in the DL subframe 120. The resource allocation header 104 also may include a UL-MAP message, which specifies resource allocations for a ranging subchannel 108 and for UL-bursts 110A-110D in the UL subframe 130. The quantity and size of the DL-bursts and UL-burst may vary depending on application.

As shown in FIG. 1, unallocated resource regions 112 may exist in the DL subframe 120 and/or in the UL subframe 130. The unallocated regions represent, for example, regions that are not defined by the resource allocation header and/or regions assigned to a user ID that does not exist in the network. The unallocated resource regions 112 may be due to scheduling factors such as the number of users, system throughput, system latency, user signal-to-noise ratio (SNR), and availability of transmit data. In some embodiments, the location of the unallocated resource regions 112 with a frame is predetermined. For example, the unallocated regions may be predetermined for a given system to allow for proprietary communication between equipment such as basestations and/or user equipment. Alternatively, the location of the unallocated resource regions 112 within a frame is random. In accordance with some embodiments, filler data such as random data and/or control data (not just zeros) is inserted into the unallocated resource regions 112.

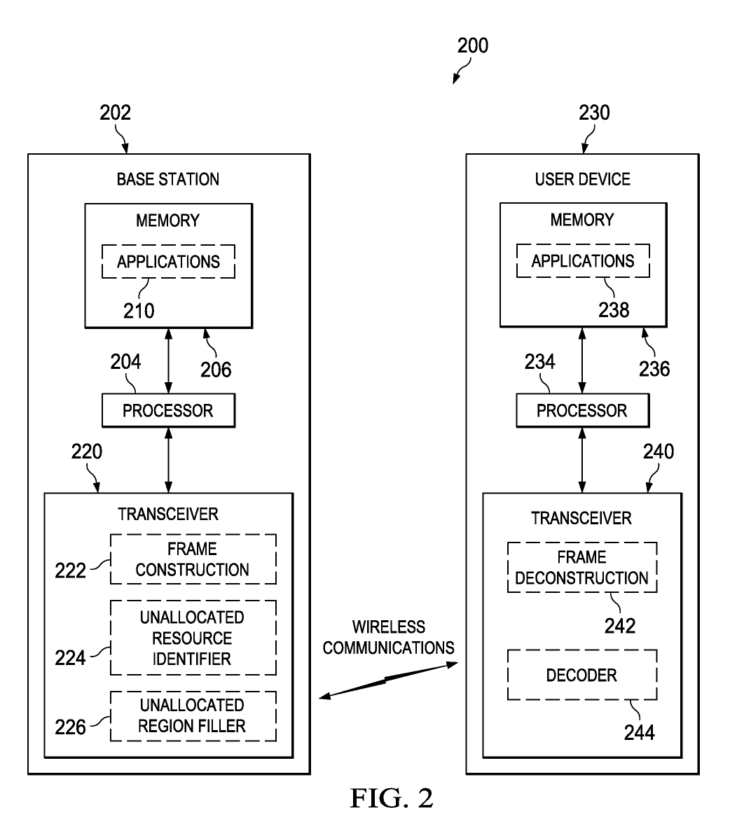

FIG. 2 illustrates a system 200 in accordance with embodiments of the disclosure. In FIG. 2, a base station 202 is in communication with a user device 230. In alternative embodiments, similar systems may have a basestation in communication with multiple user devices, multiple base stations in communication with each other or multiple user devices in communication with each other. As shown, the base station 202 comprises a processor 204 coupled to a memory 206 that stores applications 210 for execution by the processor 204. The applications 210 could comprise any known or future application useful for individuals or organizations. As an example, such applications 210 could be categorized as operating systems, device drivers, databases, multimedia tools, presentation tools, Internet browsers, emailers, Voice Over Internet Protocol (VOIP) tools, file browsers, firewalls, instant messaging, finance tools, games, word processors or other categories. Regardless of the exact nature of the applications 210, at least some of the applications 210 may direct the base station 202 to transmit signals to the user device 230.

To transmit signals, the base station's transceiver 220 implements a frame construction component 222, an unallocated resource identifier component 224 and an unallocated resource filler component 226. These components can be implemented as hardware, firmware, software, or a combination thereof. In at least some embodiments, the frame construction component 222 prepares DL subframes by allocating a preamble, a FCH, a resource allocation header, and DL-bursts to available resource regions. Similarly, the frame construction component 222 prepares to receive data back from the user device 230 by allocating ranging sub-channels and UL-bursts to available resource regions. The various resource regions can be allocated according to scheduling factors such as the number of users, throughput and latency.

Once the DL subframe is prepared, the unallocated resource identifier component 224 searches for unallocated resource regions within the DL subframe. The search for unallocated resource regions can occur after each subframe is prepared. In at least some embodiments, the unallocated resource identifier component 224 identifies unallocated resource regions based on the scheduling factors and/or based on information received from the frame construction component 222.

If the unallocated resource identifier component 224 finds an unallocated resource region, the unallocated resource filler component 226 inserts filler data into the unallocated resource region. In some embodiments, the filler data comprises random data (not just zeros). The magnitude and phase of the random data can be predetermined or selected based on user input. For example, if maintaining the same average power across symbols is desired, the filler data may correspond to a random sequence of constellation points with the same digital modulation scheme (e.g., QPSK, 16QAM, 64QAM as so on) as non-filler symbol data. Alternatively, if reducing the Peak-to-Average Power Ratio (PAPR) for transmitted symbols is desired, the filler data may correspond to a sequence of constellation points that reduces the PAPR for the symbol(s) associated with the unallocated resource region. In other words, the magnitude and phase of constellation points can be carefully selected to reduce PAPR for the corresponding symbol(s) or can provide some other desired power characteristic. Alternatively, the filler data may be control data. For example, the control data could correspond to communications between basestations to synchronize time, provide handover information, system configuration, or other information. The control data could also correspond to communications between user devices to provide a private communication channel (e.g., for sharing data).

If a plurality of unallocated resource regions are identified, the same or different types of filler data may be inserted into each region. In at least some embodiments, random filler data is inserted into unallocated resource regions by default. Upon request (e.g., by a user or administrator), control data or PAPR reducing data can be inserted into unallocated resource regions. In general, the types of filler data used for each unallocated resource regions can be predetermined or based on user input. Also, the time-frequency location of the unallocated regions within the frame can be predetermined. In other words, inserting random data, PAPR reducing data, and/or control data into unallocated resource regions may be predetermined, based on user input, or based on usage scenarios.

Upon allocating resource regions and filling in unallocated resource regions, the transmitter 220 transmits the prepared DL subframe to the user device 230. As shown, the user device 230 comprises a processor 234 coupled to a memory 236 that stores applications 238 for execution by the processor 234. The applications 238 could comprise any known or future application useful for individuals or organizations. As an example, such applications 238 could be categorized as operating systems, device drivers, databases, multimedia tools, presentation tools, Internet browsers, emailers, Voice Over Internet Protocol (VOIP) tools, file browsers, firewalls, instant messaging, finance tools, games, word processors or other categories. Regardless of the exact nature of the applications 238, at least some of the applications 238 may interact with data transmitted from the base station 202 and received by the user device 230.

To receive signals, the transceiver 240 implements a frame de-construction component 242 and a decoder component 244. These components can be implemented as hardware, firmware, software, or a combination thereof. In at least some embodiments, the frame de-construction component 242 deconstructs each DL subframe based on the resource allocation header and/or scheduling factors. Thus, the frame de-construction component 242 may appropriately identify resource regions where data bursts were transmitted and resource regions with filler data. Also, the frame de-construction component 242 may appropriately identify resource regions where UL-bursts are to be transmitted.

After deconstruction of the received frame, the decoder component 244 is able to decode data according to any of a variety of decode schemes. The decoded data (e.g., DL-burst data) may be utilized by one or more of the applications 238. In at least some embodiments, the decoder component 244 is able to decode filler data, which may be control data as previously described. If the filler data is not needed by the device, decoding the filler data is omitted. In such case, the filler data would still affect the power characteristics of the transmitted signal.

In at least some embodiments, the base station 202 may comprise receiver components (e.g., a frame deconstruction component and the decoder component) as were described for the user device 230. Likewise, the user device 230 may comprise transmitter components (e.g., a frame construction component, an unallocated resource identifier component and an unallocated region filler component) as were described for the base station 202.

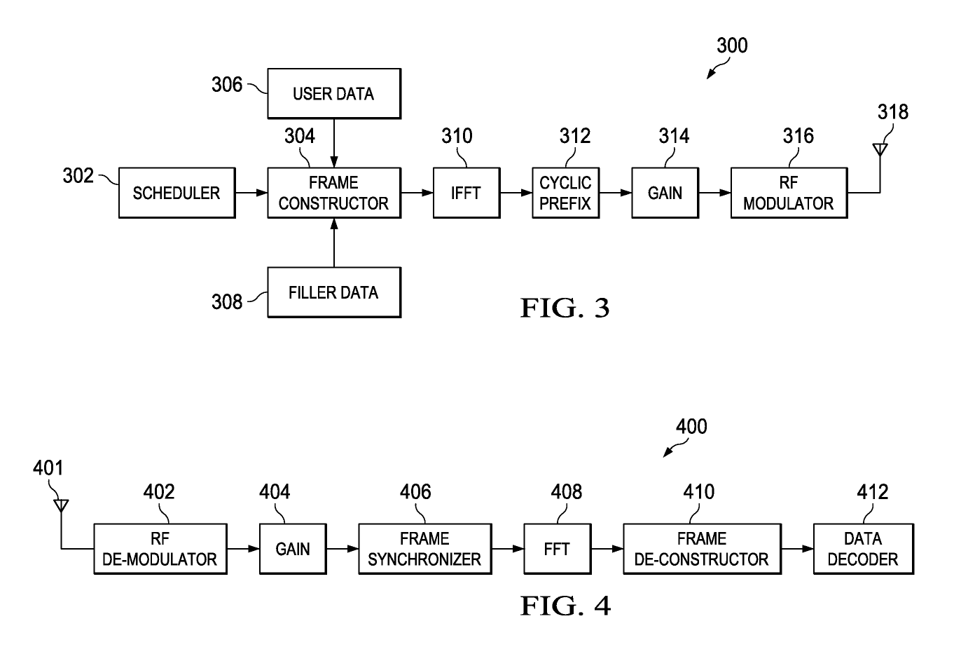

FIG. 3 illustrates a transmitter 300 in accordance with embodiments of the disclosure. The transmitter 300 is representative of components implemented by the transceivers of base station 202 or the user device 230. As shown, the transmitter 300 comprises a scheduler 302 coupled to a frame constructor 304. The scheduler 302 accounts for scheduling factors (e.g., the number of users, throughput, user SNR, and latency) and provides related information to the frame constructor 304. The frame constructor 304 prepares a frame for transmission based on the scheduling factors. Allocated resource regions in the constructed frame are filled with user data 306 (i.e., data for user devices). Any unallocated resource regions in the constructed frame are filled with filler data 308. The filler data maintains a desired power characteristic for transmitted symbols and/or provides control data. As previously described, the filler data may be predetermined or based on user input.

Once a frame has been constructed and unallocated regions are filled, the frame is forwarded to an Inverse Fast-Fourier Transform (IFFT) block 310, which maps data of the frame to sub-carriers. The cyclic prefix block 312 then adds a cyclic prefix to data of the frame to provide multi-path immunity and tolerance for synchronization errors. The gain block 314 amplifies the signal as may be needed to improve signal reception. In some cases, the amplification is based on information received from a receiving device.

The radio frequency (RF) modulator 316 modulates the signal from the gain block 314 to the desired RF carrier frequency needed by the particular OFDMA wireless communication protocol. The modulated symbols are output to an antenna 318 of the transmitter 300.

FIG. 4 illustrates a receiver 400 in accordance with embodiments of the disclosure. As shown, the receiver 400 comprises an antenna 401 that receives or “picks-up” transmitted signals. Received signals are input to an RF de-modulator 402, which reverses the operation of the RF modulator 316 of FIG. 3. The gain block 404 adjusts the receiver sensitivity based on the strength of the received signal. For example, in at least some embodiments, transmitting only zeros in unallocated resource regions may cause the gain block 404 to increase the gain as the received signal would appear to diminish in strength. By appropriately inserting filler data in unallocated resource regions, sensitivity adjustments by the gain block 404 are advantageously reduced.

A frame synchronizer 406 receives the output of the gain block 404 and corrects time and frequency offsets. Subsequently, the received signal is forwarded to a Fast-Fourier Transform (FFT) block 408. The FFT block 408 extracts frequency information of the sub-carriers. Once the FFT has been performed on the received signal, a frame de-constructor block 410 deconstructs the received frame based on the resource allocation header 104 and/or other information that specifies the resource region boundaries. The deconstructed frame is then decoded by a data decoder 412. Various decoding schemes may be implemented as understood by those of skill in the art.

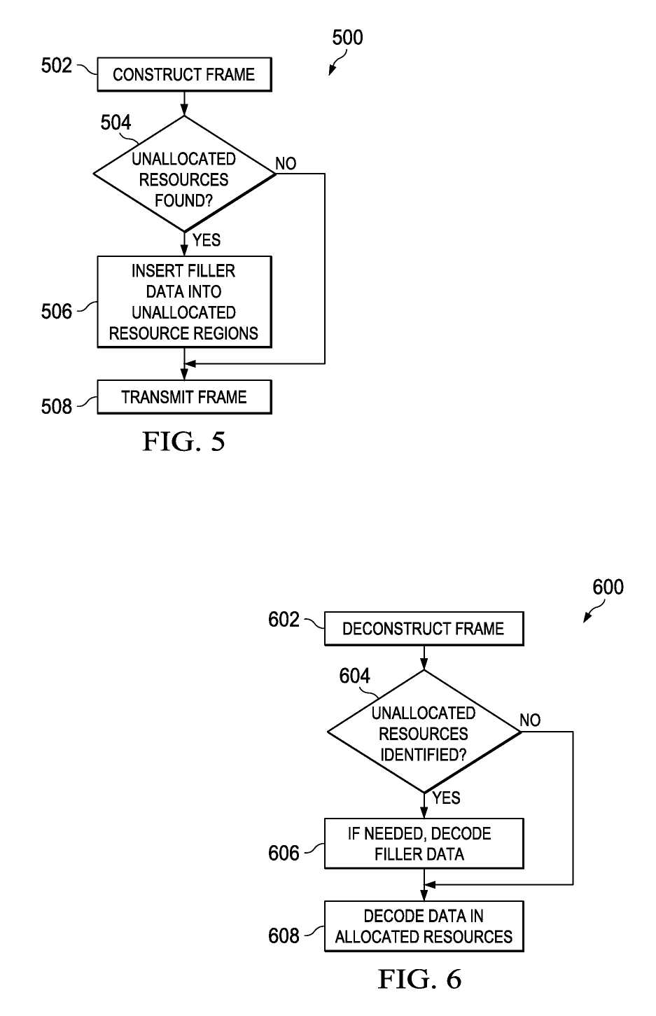

FIG. 5 illustrates a transmitter method 500 in accordance with embodiments of the disclosure. The method 500 comprises constructing a frame (block 502). If unallocated resources are found (determination block 504), filler data is inserted into unallocated resource regions (block 506). In at least some embodiments, the filler data comprises random data by default and control data upon request. In some embodiments, the filler data comprises a sequence of random constellation points with a same digital modulation scheme as non-filler symbol data. In some embodiments, the filler data comprises a sequence of constellation points that reduces a Peak-to-Average Power Ratio (PAPR) of a symbol associated with the filler data. If unallocated resources are not found (determination block 504) or if filler data has already been inserted into unallocated resource regions (block 506), the frame is transmitted (block 508).

FIG. 6 illustrates a receiver method 600 in accordance with embodiments of the disclosure. The method 600 comprises deconstructing a frame (block 602). If unallocated resources are identified (determination block 604), filler data is decoded (block 606). In some cases, the filler data comprises control data that can be decoded. In other cases, the filler data comprises random data that does not need to be decoded (no meaningful data is provided). If unallocated resources are not identified (determination block 604) or if filler data has already been decoded (block 606), data in allocated resources of the frame is decoded (block 608).

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A system, comprising:
a first device that prepares a frame for transmission; and
a second device in communication with the first device,
wherein the first device is configured to identify unallocated resource regions in the prepared frame and insert filler data in the unallocated resource regions.

2. The system of claim 1 wherein the first and second devices communicate using Orthogonal Frequency Division Multiple Access (OFDMA) frames.

3. The system of claim 1 wherein the filler data comprises random data.

4. The system of claim 1 wherein the filler data comprises control data.

5. The system of claim 1 wherein a location of the unallocated resource regions within the frame is predetermined.

6. The system of claim 1 wherein a location of the unallocated resource regions within the frame is random.

7. The system of claim 1 wherein the filler data comprises constellation points having a same digital modulation scheme as non-filler symbol data.

8. The system of claim 1 wherein the filler data comprises a sequence of constellation points that reduces a Peak-to-Average Power Ratio (PAPR) of a symbol associated with the filler data.

9. The system of claim 1 wherein the first device comprises a base station and the second device comprises a user equipment device.

10. The system of claim 1 wherein the first and second devices comprise base stations.

11. The system of claim 1 wherein the first and second devices comprise user equipment devices.

12. The system of claim 1 wherein the second device is configured to decode the filler data.

13. The system of claim 1 wherein multiple types of filler data are supported and wherein a user selects at least one type of filler data for insertion in each unallocated resource region.

14. A transmitter, comprising:
a scheduler;
a frame constructor coupled to the scheduler, the frame constructor allocates time/frequency resource regions for a frame based on information from the scheduler; and
a filler data controller coupled to the frame constructor,
wherein, if a resource region goes unallocated, the filler data controller inserts filler data in the unallocated resource region.

15. The transmitter of claim 14 wherein the filler data controller supports multiple types of filler data and wherein the filler data controller selects at least one type of filler data for each unallocated resource region based on user input.

16. The transmitter of claim 14 wherein the filler data controller supports multiple types of filler data and wherein the filler data controller selects at least one type of filler data for each unallocated resource region based on predetermined settings.

17. A method, comprising:
preparing a frame for wireless communication;
identifying whether the frame has an unallocated resource region; and
if the frame has an unallocated resource region, inserting filler data in the unallocated resource region.

18. The method of claim 17 wherein inserting filler data in the unallocated resource region comprises inserting random data by default and control data upon request.

19. The method of claim 17 wherein inserting filler data in the unallocated resource region comprises inserting constellation points having a same digital modulation scheme as non-filler symbol data.

20. The method of claim 17 wherein inserting filler data in the unallocated resource region comprises inserting a sequence of constellation points that reduces a Peak-to-Average Power Ratio (PAPR) of a symbol associated with the filler data.
